(19) United States
(12) Patent Application Publication
(10) Pub. No.: US 2002/0031467 A1
(43) Pub. Date: Mar. 14, 2002

(54) Process for the utilization of halogen containing remainders and waste materials

(75) Inventors: Manfred Schingnitz, Freiberg (DE); Jurgen Gorz, Freiberg (DE); Heinz Hackel, Rostock (DE); Dietmar Adler, Siebenlehn (DE)

Correspondence Address: Thomas C. Pontani, Esq., Cohen, Pontani, Lieberman & Pavane, 551 Fifth Avenue, Suite 1210, New York, NY, 10176, US

(73) Assignee: Noell-KRC Energie-und Umwelttechnik GmbH

(21) Appl. No.: 09/736,553

(22) Filed: Dec. 13, 2000

(30) Foreign Application Priority Data
Dec. 13, 1999 (DE) 199 60 075.9

(51) Int. Cl. C01B 7/00

(52) U.S. Cl. 423/481

(57) ABSTRACT

A method for gasification of halogen containing remainders and waste materials is provided including obtaining a reactant including halogen containing remainders and/or halogen containing waste, and where necessary an additional combustible. The reactant has a heat value of greater than 6 MJ/kg and is reacted with a gasification agent containing free oxygen into a crude gas using a flame reaction at a pressure in excess of ambient pressure to a final temperature of at least 1100° C. The crude gas contains carbon monoxide, hydrogen-containing gas and/or halogen/hydrogen containing gas. The crude gas can then be cooled and further processed.

### BACKGROUND OF THE INVENTION

1. Field of the Invention

The present invention relates to a process for the utilization of halogen-containing remainders and waste materials.

The invention is suited for nonhazardous use of organic and inorganic remainders and waste materials while generating valuable materials and a carbon monoxide-containing and hydrogen-containing gas through gasification using the principle of partial oxidation in entrained flow. By halogen-containing remainders and waste materials is meant hydrocarbon oils charged with organic halogen compounds, halogen-containing solvents and plastics, halogen-containing hydrocarbons occurring as remainders or intermediate products, halogen-containing salts or solutions thereof, and halogen-containing dyes, varnishes, pesticides and herbicide wastes.

2. Description of the Related Art

It is known to burn carbon containing and halogen containing remainders and waste materials while using of the heat generated and obtaining halogen acids or halogen-containing salts. However, there is the danger that highly toxic substances will form during the combustion process or during subsequent cooling, the disposal or destruction of which is very costly. A general overview is contained in “Thermal Waste Treatment [Thermnische Abfallbehandlung]”, K. J. Thomé-Kozmiensky, EF-Verlag für Energie-und Umwelttechnik GmbH, 1994.

In gas generation technology, it is known to gasify remainders and waste materials which are in the free-flowing state, or which can be changed into this state, through partial oxidation in the entrained flow. German reference DE 41 09 231 C2 describes a process for gasifying halogen-charged carbon-containing materials and waste materials with the primary aim of generating a gas high in carbon monoxide and hydrogen which can be used in a variety of ways. For this purpose, the halogen-containing waste materials are converted into a carbon monoxide-containing or hydrogen-containing crude gas in an entrained flow process with an oxygen-containing gasification agent at elevated pressure. This crude gas is brought into contact with a quantity of water provided with an addition of an alkaline-reacting additive and is cooled. The halogen hydrogen acids contained in the crude gas are dissolved in water and bonded with the alkaline-reacting additive to form alkali halides. Further, the pH of the water is measured and regulated by adding the alkaline-reacting additive in such a way that no halogen hydrogen acid is carried away with the cooled crude gas. The alkali halides are found in waste water and are removed or obtained by appropriate methods.

This method of utilization of halogen-containing materials is limited to relatively small concentrations of halogen. With higher concentrations that occur in multiple-halogenated hydrocarbons, the salt contents in the waste water would be too high. Further, in hydrocarbons halogenated multiple times, there is a risk that under certain conditions the conversion to halogen hydrogen does not run to completion and the formation of elementary halogens occurs.

### SUMMARY OF THE INVENTION

It is the object of the present invention to utilize halogen-containing remainders and waste materials, including those with high halogen concentrations, through partial oxidation in the entrained flow, preferably while obtaining halogen hydrogen acids and gas high in carbon monoxide and hydrogen. Formation of thermodynamic soot, highly toxic halogen free hydrocarbons, halogen containing hydrocarbons as well as formation of elementary halogens is avoided.

This object is achieved by the complete conversion of the halogen-containing remainders and waste material to halogen hydrogen without the formation of elementary halogens, thermodynamic soot, toxic halogen-containing hydrocarbons and halogen-free hydrocarbons, when the product to be gasified has a heat value greater than 6 MJ/kg and the gasification temperatures are at least 1100° C. If the material or reactant to be gasified, namely, halogen containing remainders and waste materials, does not attain this heat value, then liquid, solid or gaseous combustibles can be added and gasified simultaneously with the remainders and waste material. The hot halogen hydrogen-containing crude gas leaving the entrained flow gasification process is washed and cooled with surplus water, wherein halogen hydrogens are preferably dissolved accompanied by formation of halogen hydrogen acids. The cooling can also be carried out with halogen hydrogen acid circulating in the process, so that higher concentrations are formed. It is advisable to remove precipitated solids from the circulating halogen hydrogen acids. The steam-saturated crude gas is subsequently subjected to additional washing processes in order to remove the halogen hydrogens from the crude gas and reclaim them as completely as possible. The crude gas that is high in carbon monoxide and hydrogen can be processed according to the prior art to form gas for energy or special synthesis gases through additional steps, e.g., desulfurizing or conditioning.

For moderation of the flame temperature, the gasification material can be supplied to the gasification reactor together with steam. In order to utilize waste heat, it is also possible for the crude gas leaving the entrained flow reactor with a temperature greater than 1100° C. to be cooled first indirectly in a heat exchanger and subsequently to be brought into contact with water for further cooling and to remove the soluble components.

Preferably, the hot crude gas having a temperature of at least 1100° C. passes through the following cooling stages:

partial cooling through contact with a limited amount of water which completely evaporates and passes into the crude gas;

indirect cooling in a heat exchanger with utilization of steam or hot water; and

cooling to ambient temperature, combined with absorption of soluble gas components.

As an alternative, the hot crude gas can be brought into contact with circulating water that has already absorbed gaseous components of the crude gas.

It is further advantageous for the process that the circulating water is freed of entrained solids before coming into contact with the crude gas.

After cooling, for further absorption of soluble gaseous compounds from the crude gas, the crude gas can be brought into intensive contact with water or in the circuit of water in which gaseous components of the crude gas are already contained.

It is further advantageous that the water which is enriched with gaseous components from the crude gas is processed to obtain valuable materials.

The residual gas which is high in CO and H₂ can be processed to form energy gas or synthesis gas after complete or partial removal of components soluble in water.

It may also be advantageous to simultaneously supply several liquid or liquid and solid or solid halogen-type remainders and waste materials which are soluble or insoluble in one another to the gasification process in the entrained flow.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows the gasification of halogen-containing remainders and waste materials through direct cooling with water surplus; and

FIG. 2 shows the gasification of halogen-containing remainders and waste materials with indirect cooling.

### DETAILED DESCRIPTION OF THE PRESENTLY PREFERRED EMBODIMENTS

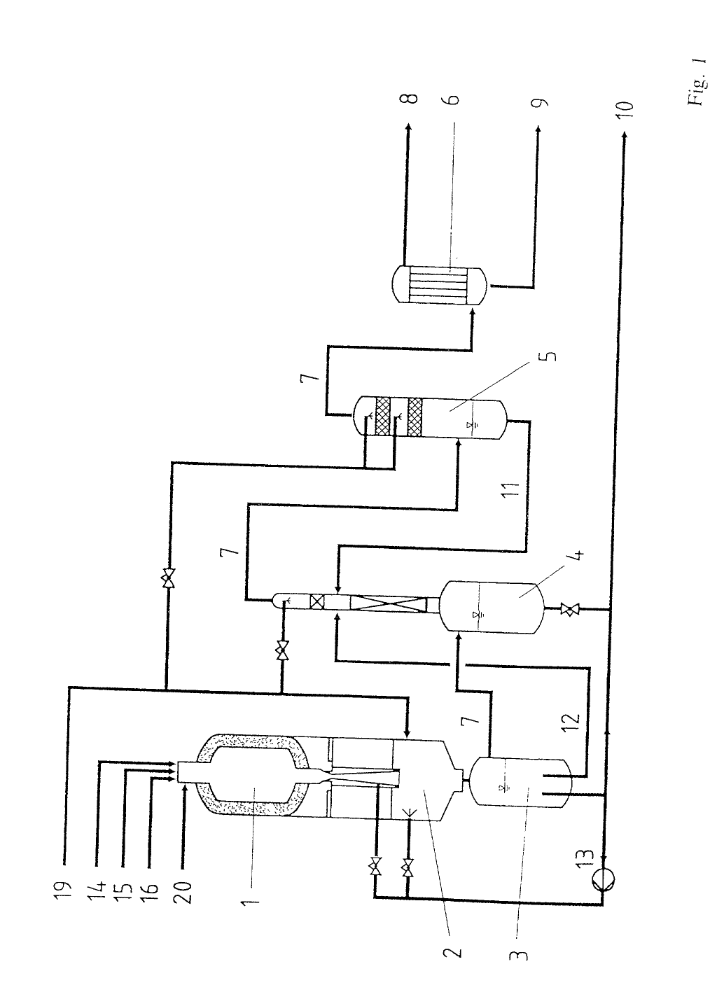

In the embodiment according to FIG. 1, the remainders and waste material 14, together with oxidants 15 containing free oxygen and possibly with steam 16 as a temperature moderating agent, is supplied to the entrained flow reactor 1 where the reaction to form crude gas containing carbon monoxide, hydrogen and halogen hydrogen is performed. The remainders and waste material can be supplied as a mixture of different components or as a multiple component flow in separate lines. By supplying an additional combustible 20, it is ensured that the heat value of the remainders and waste material gasification materials, plus added combustibles, is greater than 6 MJ/kg to ensure complete conversion of the halogen-containing components to halogen hydrogens. The crude gas leaving the entrained flow reactor 1 at a temperature of at least 1100° C. is cooled in the quenching cooler 2 by injecting fresh water 19 and water 13 that is guided in circulation and already enriched with soluble gas components. The water 13 that is already enriched can be taken off as valuable material in the form of halogen hydrogen acid 10 or can be delivered to the absorber 4 for further absorption of soluble components. In order to remove halogen hydrogen traces as well, the crude gas arrives in the fine cleaning stage 5 where fresh water 19 is applied to it. The discharge 11 from the fine cleaning stage 5 is guided to the absorber 4. The crude gas 7′ from which halogen hydrogens have been removed is cooled indirectly in the cooler 6 and is available for further utilize as a pure gas 8 high in carbon monoxide and hydrogen. The condensate 9 running off in the cooler 6 can be returned to the cooling and washing process together with the fresh water 19.

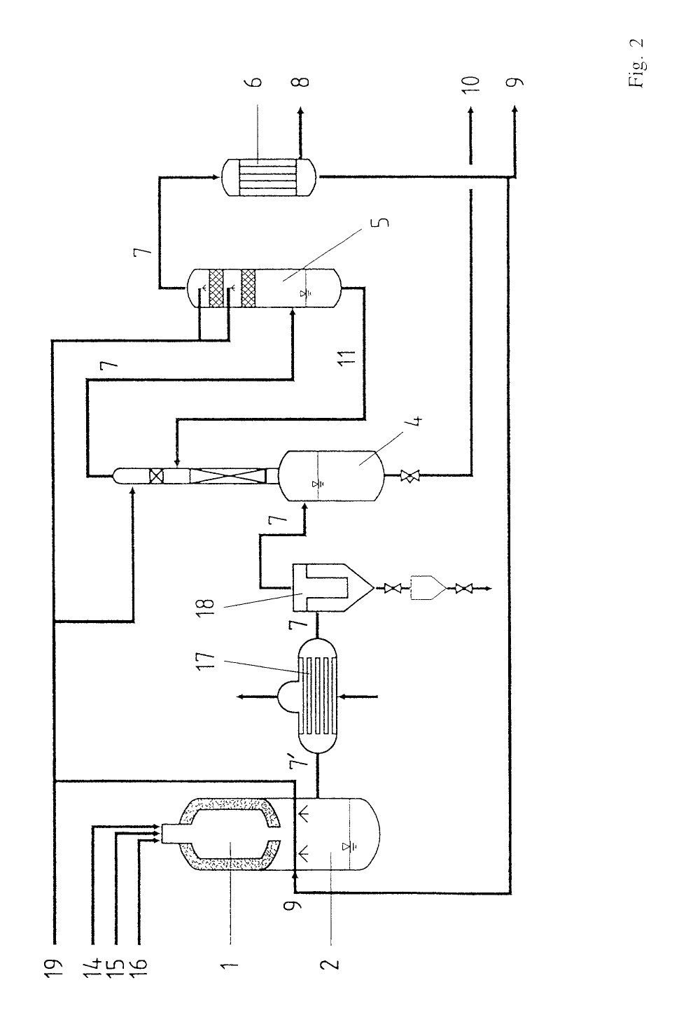

Referring now to FIG. 2, the crude gas having a temperature of at least 1100° C. undergoes limited cooling by injection of a limited amount of condensate 9 or fresh water 19, wherein the entire amount 9 and 19 supplied is evaporated. The crude gas 7 which is partially cooled, but still hot, reaches the heat exchanger 17 in which further cooling takes place through steam generation. Dust particles that have possibly been carried along are precipitated out in the hot gas filter 18. The temperature of the crude gas can be readily regulated within a wide range by adding different amounts of fresh water 19 and condensate 9. If the supply of fresh water 19 and condensate 9 is dispensed with entirely, the crude gas 7 is fed to the heat exchanger 17 at the temperature at which it exits from the entrained flow gasifier (i.e., greater than 1100° C.). Downstream of the hot gas filter 18, washing of the crude gas 7 is performed in the absorber 4 and fine cleaning stage 5 for absorption of soluble gas components. Fresh water 19 and the flow-off from the fine cleaning stage 5 is admitted to the absorber. The condensate 9 can also be returned to circulation. The rest of the cooling takes place in the cooler 6, after which the pure gas 8 is available for use or for further treatment.

Thus, while there have been shown and described and pointed out fundamental novel features of the present invention as applied to a preferred embodiment thereof, it will be understood that various omissions and substitutions and changes in the form and details of the devices illustrated, and in their operation, may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

We claim:

1. A method for gasification of halogen containing remainders and waste materials, comprising the steps of:
obtaining a reactant comprising at least one of halogen containing remainders and a halogen containing waste material having a heat value of greater than 6 MJ/kg;
reacting the reactant and a gasification agent containing free oxygen into a crude gas using a flame reaction at a pressure in excess of ambient pressure to a final temperature of at least 1100° C., the crude gas including carbon monoxide, hydrogen containing gas and halogen/hydrogen containing gas;
contacting the crude gas with a predetermined quantity of water for cooling and saturating the crude gas by evaporation of a part of the predetermined quantity of water with steam; and
absorbing at least one of solid components, liquid components and gaseous components of the crude gas that are soluble in water using a remainder of the predetermined quantity of water that has not been evaporated.

2. The process according to claim 1, wherein the obtaining step includes obtaining a reactant further comprising an additional combustible material.

3. The process according to claim 1, further comprising the step of:
cooling the crude gas having a temperature of at least 1100° C. indirectly by heat recovery before the contacting step.

4. The process according to claim 3, further comprising the further cooling steps of:
exposing a limited amount of water to the crude gas, wherein the limited amount of water completely evaporates;
performing indirect cooling in a heat exchanger with recovery of one of steam and hot water; and
cooling the crude gas to ambient temperature while absorbing soluble gas components from the crude gas.

5. The process according to claim 3, wherein the contacting step comprises contacting the hot crude gas with at least one of the predetermined quantity of water and a circulating water that has already absorbed the gaseous components of the crude gas.

6. The process according to claim 4, further comprising the step of:
removing entrained solid materials from the water prior to contacting the crude gas with the water.

7. The process according to claim 3, further comprising the step of:
contacting one of water and a circuit of water already containing gaseous components of the crude gas intensively with the crude gas so as to further absorb the water soluble gaseous compounds from the crude gas.

8. The process according to claim 6, further comprising the further step of:
processing the water containing the gaseous components removed from the crude gas to obtain valuable materials.

9. The process according to claim 6, comprising the further step of:
processing a residual gas which is high in CO and H₂ to form one of energy gas and synthesis gas after one of complete and partial removal of components that are soluble in water.

10. The process according to claim 8, further comprising the step of:
supplying one of liquid, liquid/solid mixture and solid halogen containing remainders and waste materials that are one of soluble and insoluble in one another simultaneously as the reactant to the gasification process in an entrained flow.
